(19) United States
(12) Patent Application Publication
(10) Pub. No.: US 2016/0230805 A1
(43) Pub. Date: Aug. 11, 2016

(54) SHAFT OF A GAS TURBINE ENGINE IN HYBRID DESIGN

(71) Applicant: Rolls-Royce Deutschland Ltd & Co KG, Blankenfelde-Mahlow (DE)

(72) Inventor: Christoph BUSCH, Berlin (DE)

(21) Appl. No.: 15/018,182

(22) Filed: Feb. 8, 2016

(30) Foreign Application Priority Data
Feb. 9, 2015 (DE) 10 2015 202 260.9

(51) Int. Cl. F16C 3/02

(52) U.S. Cl. CPC F16C 3/026

(57) ABSTRACT

A shaft of a turbine engine made from fiber-composite material, having a sinusoidal inner profile which extends over the entire length of the shaft on its inner wall, where a first inner layer forms the sinusoidal inner profile and has fibers arranged at ±45° relative to the axial direction, where the concave outer areas of the first layer are filled with fibers parallel to the center axis by a second layer to form a cylindrical outer contour. The second layer extends in the circumferential direction only in the concave area. A third layer with fibers arranged at ±30° relative to the axial direction is provided on the second layer A fourth layer with fibers arranged at ±88° relative to the axial direction is provided on the third layer. An intermediate layer is formed between the second and third layers from fibers parallel to the axial direction.

This invention relates to a shaft of a gas-turbine engine, in particular a radial shaft or a shaft arranged at an angle to the machine axis.

Radial shafts for gas-turbine engines are mostly made of metal. They are used to start the engine, where an electric motor or an air turbine installed in an external gearbox drives the radial shaft via a gear unit. This shaft is connected via a gear unit to the high-pressure compressor of the gas turbine. For starting, the high-pressure compressor is thus put into rotation in order to start the combustion process.

During operation of the engine, the shaft is driven via the same connection in the reverse direction, in order to drive pumps and generators using an external gear unit.

Shafts of this type are subject to the following requirements: firstly the shaft has to be constructed very slender, since it must be passed through a strut in the intermediate casing or as a general principle through the second air circuit in the case of a dual-circuit/ dual-flow turbine jet engine, and hence always represents a fluid-mechanical resistance which directly affects engine output and efficiency. With regard to its geometric configuration, the shaft must be passed through openings in the engine suspension in order to connect the external gear unit to the high-pressure compressor. A further requirement is that the shaft must transmit high torques at high speeds in both directions.

Radial shafts made of metal, as known from the state of the art, come up against the limits of their usability for engine design, as these shafts are already designed to the limit of the bending-critical speed. The materials used do therefore not permit any lengthening or slimming down of the shaft geometry, which considerably hampers the development of gas-turbine engines having a smaller core engine with higher speeds and a larger fan diameter. With a larger fan and a smaller diameter of the core engine, the result is a greater distance between the core engine and an external gear unit (gearbox), which would inevitably result in longer radial shafts. They would, in the metal construction method known from the state of the art, have to be designed with thicker walls, be of larger size and, due to the problem of bending, have a centric bearing as a support. This would lead to a higher weight of the overall engine plus poorer aerodynamics.

Already known from the state of the art are engine shafts for gas-turbine engines, which are constructed from fiber layers embedded in a high-temperature resistant plastic matrix.

DE 10 2011 085 962 B4 describes an internally profiled shaft of fiber-composite material with load-introducing elements, which has a consistent cross-section over its length and possesses a cylindrical outer contour. A shaft of this type does not have, for example under the operating conditions of an aircraft engine, the required combination of torsional stiffness and speed stiffness. There is also a general risk of the individual layers delaminating and in particular of the load-introducing element becoming detached from the fiber-composite structure. Delamination occurs due to a too large fiber angle being selected between the individual fiber-composite layers, so that a marked jump in stiffness occurs.

The object underlying the present invention is to provide a shaft of an aircraft gas-turbine engine, in particular a radial shaft which, while being simply designed and easily and cost-effectively applicable, avoids the disadvantages of the state of the art and meets all requirements.

It is a particular object of the present invention to provide solution to the above problematics by a combination of the features of claim 1. Further advantageous embodiments of the present invention become apparent from the sub-claims.

The invention thus provides a new fiber-composite drive shaft design permitting manufacture of a fiber-composite shaft of this type in an extruded section while considerably increasing the speed stiffness and the torsional stiffness. In accordance with the invention, the shaft can thus be mass-produced, so that the production costs are considerably reduced. The individual shafts can then be cut to length from the continuously produced extruded section. It is furthermore possible in view of the speed stiffness and the torsional stiffness to increase the minimum inner diameter of the shaft and at the same time to reduce its maximum outer diameter. The result is thus a shaft with a reduced wall thickness in comparison to the state of the art. As a result, in addition to the higher torsional stiffness and increased speed stiffness, the installation space required is considerably reduced. The possibility of designing the shaft in accordance with the invention with a lower outer diameter has the advantage that the diameter of a casing accommodating the shaft in the installed state can also be reduced, resulting in a marked saving in weight. This in turn improves both the flow through the bypass duct of the turbine engine and the efficiency of the engine.

The shaft design provided in accordance with the invention makes it possible, as already mentioned, to cut the shaft to any required length from a continuous section. This in turn affords the possibility, depending on the respective application, of producing different lengths of shaft with the same structure. In the case of conical shafts as known from the state of the art, complete redimensioning is always necessary when lengths differ, which means that considerable effort is needed for calculation and for the tests required for approval.

The invention thus relates to a shaft of a turbine engine made from fiber-composite material, having a sinusoidal inner profile which extends over the entire length of the shaft on its inner wall, where the shaft has a constant cross-section over its length, where a first inner layer forms the sinusoidal inner profile and consists of fibers arranged at ±45° relative to the axial direction of the shaft, where the concave outer areas of the first layer are filled with fibers parallel to the center axis by means of a second layer in order to form a cylindrical outer contour, where the second layer in accordance with the invention extends in the circumferential direction both in the concave area and also as a composite over the concave areas (also referred to as intermediate layer), where a third layer with fibers arranged at ±30° relative to the axial direction of the center axis is provided on the second layer and where a fourth layer with fibers arranged at ±88° relative to the axial direction is provided on the third layer.

In accordance with the invention, a radial shaft is thus provided which is constructed and manufactured in a fiber-composite design. Metallic end pieces are here connected to a tubular intermediate section of the shaft. As a result, the overall mass of the radial shaft is reduced. The use of high-stiffness fibers results in a very steep rise in stiffness. Due to the resultant higher bending-critical speed, it is not necessary to support the shaft by an additional centric bearing. Due to the high stiffnesses and high strengths of the fiber materials, it is possible to provide very long shaft structures which can bridge the distance between a core engine and an external gearbox with no increase in the shaft diameter being necessary. The shaft in accordance with the invention is also characterized in that high torques can be transmitted and that a considerable increase in the natural frequency results.

The radial shaft in accordance with the invention can thus be designed to rotate very rapidly, so that speeds of up to 30,000 rpm can be achieved. Also, the radial shaft in accordance with the invention is able to transmit high torques, for example up to 2,000 Nm. The diameters of these radial shafts can be very low, for example up to max. 150 mm, combined with very low wall thicknesses of about 3 mm, considerably reducing the overall weight.

As described in the following on the basis of the exemplary embodiment, the second layer in accordance with the invention, which has fibers in the axial direction, leads to the optimized speed stiffness, whereas in particular the layer provided with fibers in a ±45° arrangement improves the torsional stiffness. All this leads to an increased service life of the shaft in accordance with the invention.

In a particularly advantageous development in accordance with the invention, it is provided that the second layer is formed by rod elements arranged in the circumferential direction of the shaft and preferably formed from fibers which are pre-fixed by a bonding agent to permit insertion of said rod elements during the production process.

It is particularly advantageous when the sinusoidal inner profile in the circumferential direction has wavelengths λ with amplitudes A and when the ratio of amplitude A to wavelength λ is 1:8 to 1:30. Preferably, the ratio is 1:24. The sinusoidal inner profile is preferably designed with flank angles α of 10° to 30° , and preferably 15°. This embodiment ensures an optimum transmission of forces between the metallic load-introducing elements and the fiber-composite structure of the shaft.

The fibers of the first layer arranged at ±45° relative to the axial direction consist preferably of flat and splayed carbon fiber tapes. This substantially simplifies manufacturing, too.

In the shaft in accordance with the invention, all layers of the shaft are saturated with resin and then cured, as is known from the state of the art. It is possible here in particular for the fibers of the rod elements pre-fixed with the bonding agent to be reliably and completely saturated with resin and thus cured without this resulting in structural differences and hence stiffness variations.

The shaft in accordance with the invention can be produced as a continuous section and cut to the length required for the respective application. This can be done before or after saturation with resin and the appropriate curing.

The present invention is described in the following in conjunction with the accompanying drawing, showing exemplary embodiments. In the drawing,

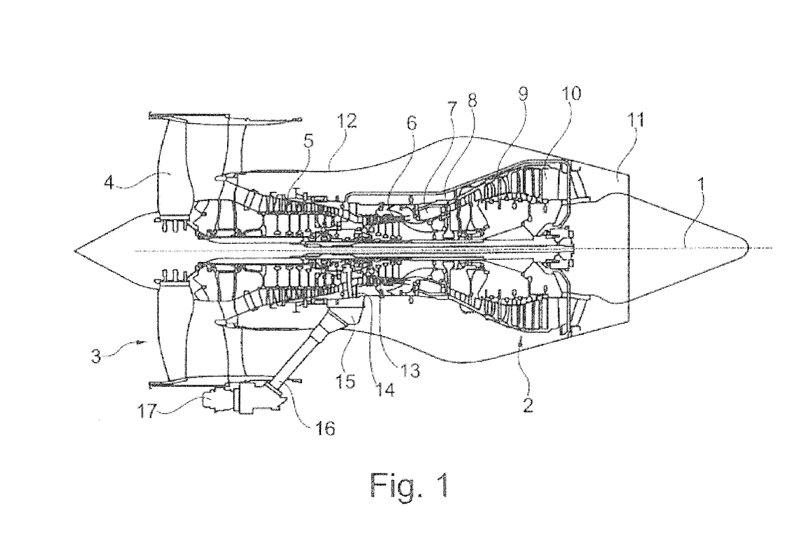

FIG. 1 shows a schematic representation of a gas-turbine engine in accordance with the present invention,

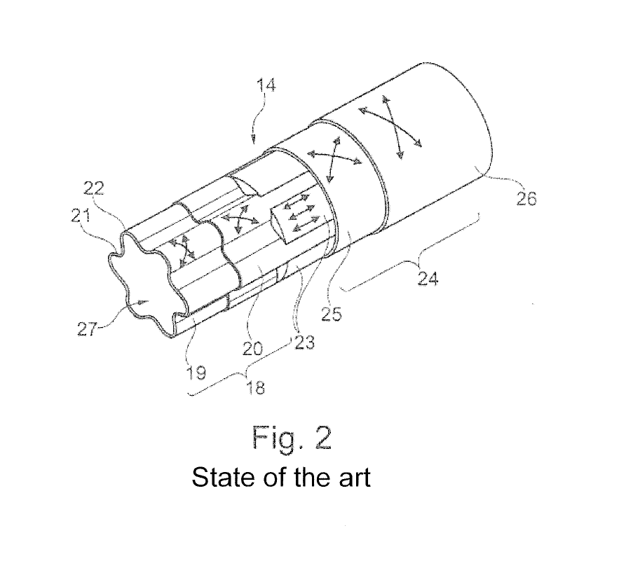

FIG. 2 shows a simplified perspective view of the structure of a fiber-composite shaft known from the state of the art,

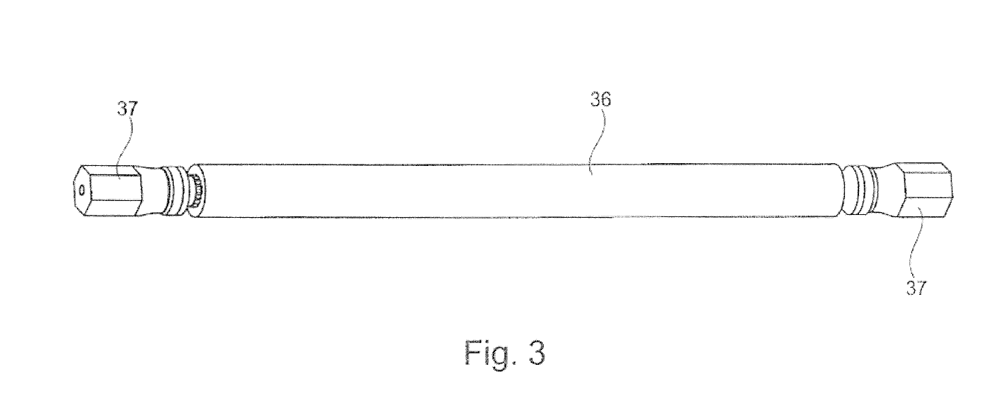

FIG. 3 shows a simplified side view of a fiber-composite shaft in accordance with the present invention,

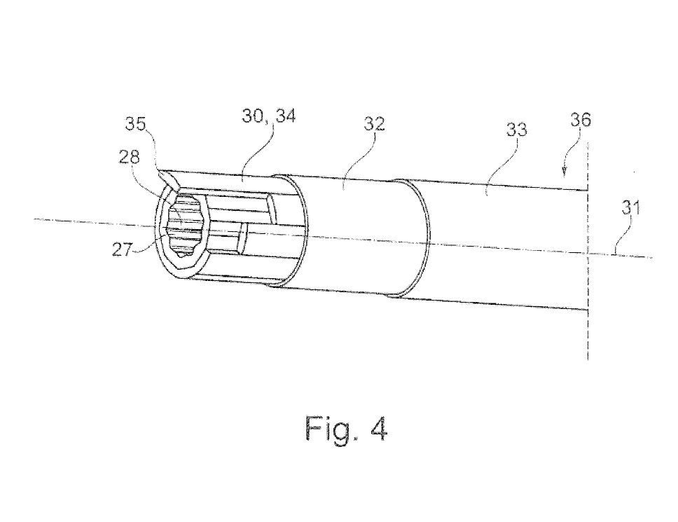

FIG. 4 shows a simplified perspective exploded view of the structure of the shaft in accordance with the present invention,

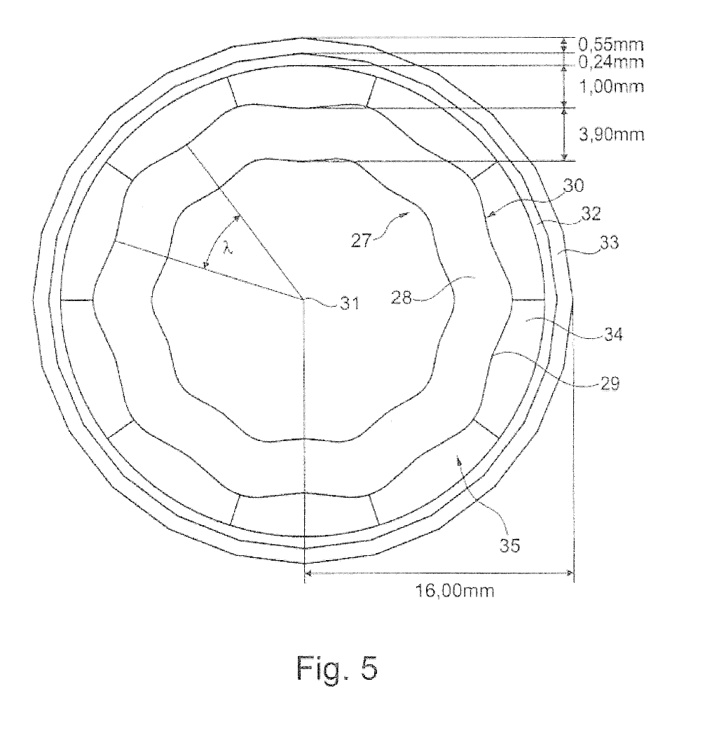

FIG. 5 shows a sectional view in a radial shaft, by analogy with FIG. 4,

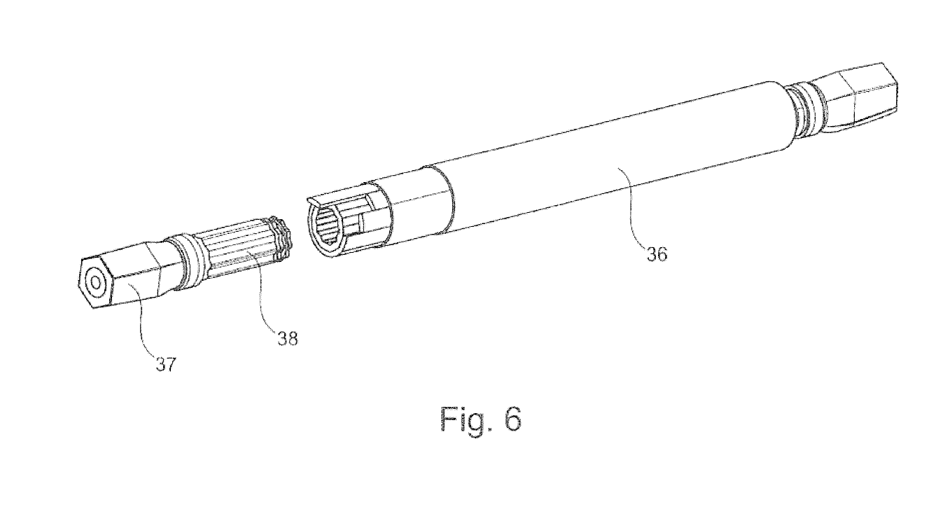

FIG. 6 shows a simplified perspective view of a fiber-composite shaft in accordance with the present invention, having a metallic load-introducing element, and

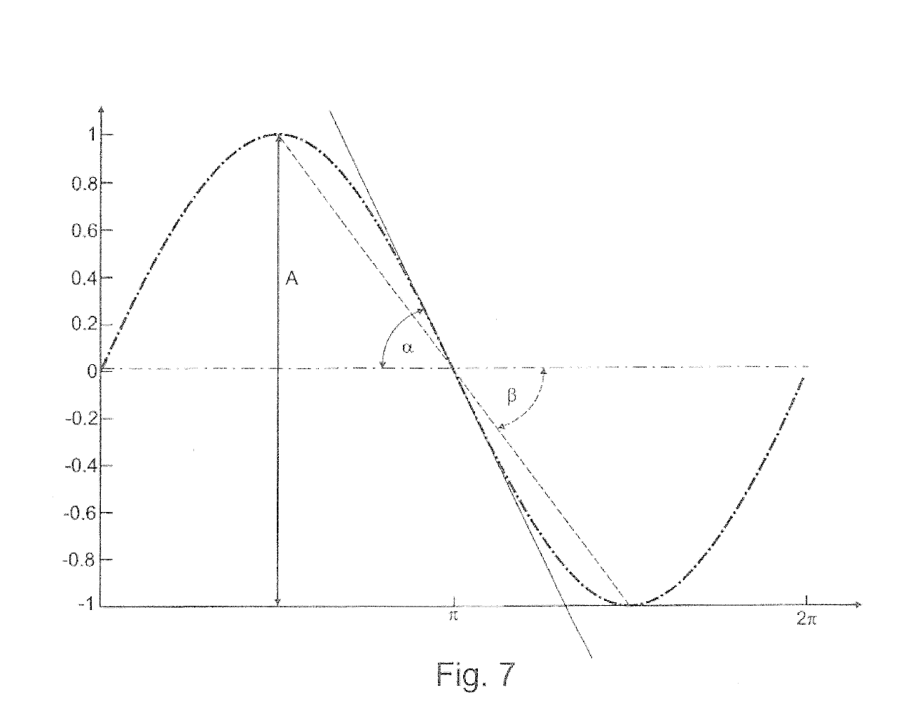

FIG. 7 shows a schematic representation of the sinusoidal shafts.

The gas-turbine engine 2 in accordance with FIG. 1 is a generally represented example where the invention can be used. The engine 2 is of conventional design and includes in the flow direction, one behind the other, an air inlet 3, a fan 4 rotating inside a casing, an intermediate-pressure compressor 5, a high-pressure compressor 6, a combustion chamber 7, a high-pressure turbine 8, an intermediate-pressure turbine 9 and a low-pressure turbine 10 as well as an exhaust nozzle 11, all of which being arranged about a center engine axis.

FIG. 1 shows an exemplary embodiment of a radial shaft in accordance with the invention, or of an engine shaft of the inventive type.

The shaft is designed either as a radial shaft 14 or as a shaft 16 arranged at an angle and is used to connect a gear unit 13 to a gear unit 15. The gear unit 15 can be operatively connected to auxiliary units. The shaft designed in accordance with the invention can also be designed in the form of a shaft 16 arranged inclined and connected to a gear unit 17 for the connection of auxiliary units.

The following description relates to a radial shaft 14, with a shaft 16 arranged at an angle being constructed in an analogous manner to this.

FIG. 2 shows in more detail the structure of a profile shaft 14 according to the state of the art. The shaft has an inner profile shell 18, consisting of a first inner layer 19 made of an FRP layer with a fiber angle of 60° relative to the axial direction of the profile shaft 14 and a second outer layer 20, also consisting of an FRP layer with a fiber angle of 45° relative to the axial direction of the profile shaft 14. The fiber directions of the individual layers are indicated by arrows. The profile shell 18 has a profile with concave areas 21 and convex areas 22, where said concave areas project inwards and thus form a recessed area on the outside.

Unidirectional strips 23 adjoin the profile shell 18 to the outside. These unidirectional strips 23 consist of FRP material with a fiber angle of 0° relative to the axial direction of the profile shaft 14. The unidirectional strips are arranged in the recesses formed by the concave areas 21, so that the unidirectional strips 23 form an approximately cylindrical shape on the outside.

A cylinder shell 24 adjoins the unidirectional strips 23 on the outside. The cylinder shell 24 consists of a first layer 25 of FRP at an angle of 45° relative to the axial direction of the profile shaft 14. The second layer 26 likewise consists of FRP material with a fiber angle of 60° relative to the axial direction of the profile shaft 14.

FIG. 3 shows a side view of a shaft in accordance with the invention. The fiber-composite shaft is identified here with the reference numeral 36. Load-introducing elements 37, each shown in simplified form, are inserted into the end areas of the fiber-composite shaft 36 and fixed there, as is known from the state of the art. The load-introducing elements are, as can be seen in particular from FIG. 6, which shows an enlarged and detailed perspective view, provided at their free ends with a toothing or a multiple contour or similar. Reference is made here to the state of the art. The load-introducing elements 37 each have a cylindrical connecting lug provided with a sinusoidal contour that serves to create a profile connection 38 to the matching inner contour of the fiber-composite shaft 36.

FIGS. 4 and 5 show respectively a perspective exploded view and a radial sectional view through the structure of the shaft in accordance with the invention.

FIGS. 4 and 5 show that the shaft has a sinusoidal inner profile 27. A first inner layer 28 is formed by the fibers arranged in ±45° layers and includes a sinusoidal outer contour with concave outer areas 29. A second layer 30 is inserted into the concave outer areas. Said second layer is formed from axis-parallel fibers and extends in the circumferential direction only in said concave outer areas 29.

An intermediate layer 34 in accordance with the invention is provided, progressing radially outwards and is also made up of axis-parallel fibers. For a better understanding, this layer is shown in FIG. 5 separately to the second layer 30. In accordance with the invention, the rod elements 35 forming the second layer 30 are designed in one piece with the intermediate layer 34, as is shown in FIG. 4. This results in a substantial advantage during production, since it is not possible in a series production process to apply a layer consisting of solely axis-parallel fibers over the circumference of the shaft such that they remain kink-free and axis-parallel in their alignment. It is however also possible as a general principle to create the two layers according to FIG. 5 independently of one another, where the already mentioned production problem arises and the properties of the shaft are negatively affected or high scrap rates result. In the embodiment according to FIG. 4, the individual rod elements 35 contact each other in the circumferential direction.

In accordance with the invention, a third layer 32 is provided on the intermediate layer 34 and is formed from fibers in ±30° layers. A fourth layer 33 is provided on the outside and consists of fibers with ±88° layers.

The ratio between amplitude A and wavelength λ was optimized in comparative tests.

Iterative calculations have shown here that the best results for the mechanical loading capacity of the sinusoidal contour consisting of ±45° layers are achieved when the ratio of amplitude to wavelength is from 1:8 to 1:30, particularly 1:24. This was made clear regardless of how many “teeth” (sinusoids) are provided in the contour. This ratio of amplitude to wavelength corresponds to flank angles α of 10° to 30°, in particular 15°.

FIG. 5 furthermore shows examples of dimensions for the thicknesses of the layers for a shaft with an outer radius of 16 mm or an outer diameter of 32 mm.

FIG. 7 shows schematically a wave of the sinusoids for defining the stated flank angle α (tangent at turning point). In addition, the angle β is shown, which reproduces the tangent of amplitude A, where α>β.

| | Example: | | | | | |
|---|---|---|---|---|---|---|
| | D = | | | | | D = 32 |
| | 80 | D = 32 | D = 30 | D = 35 | D = 85 | max. |
| A (amplitude) in | 0.5 | 0.27 | 0.25 | 0.7 | 0.7 | 2.1 |
| mm | | | | | | |
| λ (wave length) | 12 | 7.8 | 6 | 6.2 | 16.8 | 11.6 |
| in mm | | | | | | |
| K = A/λ | 24 | 24.9 | 24.4 | 8.8 | 24 | 5.6 |

It was shown in the state of the art that there is a detrimental effect on the torsion frequency and natural frequency properties of the shaft when all layers formed by fibers arranged in the axial direction are inserted into the concave areas of the sinusoids (teeth) (as the shafts of the state of the art were designed). Calculations for approximation to the maximum number of layers formed by fibers arranged in the axial direction in the sinusoidal troughs resulted in a maximum ratio of amplitude to wavelength of 1:5. With higher ratios, the rise in the sinusoids becomes so large that the sinusoidal flanks (tooth flanks) form too large a surface area and the mechanical loading capacity drops steeply. In addition, the rise in the following ±45° layers becomes so large that they are no longer continuously curved, but instead would have to be kinked, which cannot be achieved for production reasons. This furthermore leads to a non-homogeneous fiber direction, which impairs the mechanical properties of the shaft. To counteract this, the intermediate layer of fibers likewise arranged in the axial direction was inserted in accordance with the invention. The lower the ratio of sinusoidal amplitude to wavelength, the better the mechanical loading capacity (torsion). With too low amplitudes, however, the risk increases of the load-introducing element (insert) slipping through at high torsional loads, since the sinusoidal contour approximates to a circle. Here the optimum ratio in accordance with the invention for amplitude to wavelength proved to be 1:24. The ratio of fibers arranged in the axial direction in the concave area of the sinusoids and of the intermediate layer in accordance with the invention, with a fiber volume content of 1:10 to 4:10, forms in accordance with the invention the optimum ratio for utilization of the available installation space and of the mechanical loading capacity in fiber-composite shafts. Reference is made here in each case to the diameter or the radial dimensions.

With regards to the radial thickness ratios of the individual layers, the following has proved particularly advantageous in accordance with the invention, for shafts with speeds in the region of 30,000 rpm and torques of 2,000 Nm: relative to the overall thickness of the fiber-composite structure of the shaft, relative to the sinusoidal inner contour and to the lowest point of the concave areas, the ±45° layers have 70% of the overall thickness. The ±30° layers have 2% of the overall thickness, while the ±88° layers make up 10% of the overall thickness. The axis-parallel layers thus have a share of 18%.

### LIST OF REFERENCE NUMERALS

1 Engine axis

2 Gas-turbine engine /core engine

3 Air inlet

4 Fan

5 Intermediate-pressure compressor (compressor)

6 High-pressure compressor

7 Combustion chambers

8 High-pressure turbine

9 Intermediate-pressure turbine

10 Low-pressure turbine

11 Exhaust nozzle

12 Engine casing

13 Gear unit

14 Shaft

15 Gear unit

16 Shaft

17 Gear unit

18 Inner profile shell

19 First inner layer

20 Second outer layer

21 Concave area

22 Convex area

23 Unidirectional strip

24 Cylinder shell

25 First layer

26 Second layer

27 Sinusoidal inner profile

28 First inner layer

29 Concave outer area

30 Second layer

31 Center axis

32 Third layer

33 Fourth layer

34 Intermediate layer

35 Rod element

36 Fiber-composite shaft

37 Load-introducing element

38 Profile connection

1. A shaft of a turbine engine made from fiber-composite material, having a sinusoidal inner profile which extends over the entire length of the shaft on its inner wall, where the shaft has a constant cross-section over its length, where a first inner layer forms the sinusoidal inner profile and consists of fibers arranged at ±30° to ±60°, in particular ±45° relative to the axial direction of the shaft, where the concave outer areas of the first layer are filled with fibers parallel to the center axis by means of a second layer in order to form a cylindrical outer contour, where the second layer in each case extends in the circumferential direction only in the concave area, where a third layer with fibers arranged at ±20° to ±45°, in particular ±30° relative to the axial direction of the center axis is provided on the second layer and where a fourth layer with fibers arranged at ±80° to ±90°, in particular ±88° relative to the axial direction is provided on the third layer, wherein between the second layer and the third layer, an intermediate layer formed from fibers parallel to the axial direction is arranged and extends over the entire circumference of the shaft.

2. The shaft in accordance with claim 1, wherein the intermediate layer is formed by rod elements adjoining each other in the circumferential direction of the shaft.

3. The shaft in accordance with claim 2, wherein the rod elements are formed from fibers which are pre-fixed by a bonding agent.

4. The shaft in accordance with claim 1, wherein the sinusoidal inner profile in the circumferential direction has wavelengths (λ) with amplitudes (A) and that the ratio of amplitude (A) to wavelength (λ) is 1:8 to 1:30.

5. The shaft in accordance with claim 4, wherein the ratio is 1:24.

6. The shaft in accordance with claim 1, wherein the sinusoidal inner profile is designed with flank angles (λ) of 10° to 30°, and preferably 15°.

7. The shaft in accordance with claim 1, wherein the first layer formed from fibers arranged at ±45° relative to the axial direction consists of flat and splayed carbon fiber tapes.

8. The shaft in accordance with claim 2, wherein the rod elements are formed from carbon fibers fixed with bonding agents which are infiltrated with resin and cured in the completed shaft.

9. The shaft in accordance with claim 1, wherein all layers of the shaft are saturated with resin and cured.

10. The shaft in accordance with claim 1, wherein latter is produced as a continuous section and cut to length.
